(19) United States
(12) Patent Application Publication
(10) Pub. No.: US 2026/0299691 A1
(43) Pub. Date: Oct. 1, 2026

(54) TACTILE FEEDBACK ON PRESENCE SENSITIVE DISPLAY

(71) Applicant: Toshiba Global Commerce Solutions, Inc., Durham, NC (US)

(72) Inventors: Yu Fen Hung, Taoyuan City (TW); Jui Chieh Guo, Taipei City (TW); Chenming Hsu, Taipei (TW); Ming Lei Lin, Taipei City (TW)

(73) Assignee: Toshiba Global Commerce Solutions, Inc., Durham, NC (US)

(21) Appl. No.: 19/095,273

(22) Filed: Mar. 31, 2025

(51) Int. Cl. G06F 3/01; G06F 3/041; G06F 3/045; G06F 3/0488

(52) U.S. Cl. CPC G06F 3/016; G06F 3/0416; G06F 3/045; G06F 3/0488

(57) ABSTRACT

Methods and systems of tactile feedback on a presence sensitive display device are performed. In one exemplary embodiment, a method is performed by an electronic device having a presence sensitive display device with a presence sensitive display and a set of presence sensitive sensors with each sensor being operable to detect a presence signal and to radiate energy. The electronic device includes a shape memory polymer film disposed on a surface of the display with the film being operable to deform responsive to radiated energy. The method includes sending to a first sensor that is proximate a location in which a virtual element of a graphical user interface is displayed, an indication associated with changing the energy radiated from that sensor so that a portion of the film proximate the virtual element is radiated to enable that portion to dynamically deform to provide tactile feedback proximate the virtual element.

### BACKGROUND

Presence sensitive displays are displays with a set of sensors operable to detect movement and proximity. For example, a capacitive touch screen includes a transparent glass panel that is coated with a conductor that is placed above an array of capacitive sensors, which is placed above a display. When a user touches the glass panel, the panel's electrostatic field changes, and the capacitive sensors within proximity of that change are operable to detect that change. Presence sensitive displays are generally flat with no hills or valleys on the display. The Background section of this document is provided to place embodiments of the present disclosure in technological and operational context, to assist those of skill in the art in understanding their scope and utility. Unless explicitly identified as such, no statement herein is admitted to be prior art merely by its inclusion in the Background section.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIG. 1 illustrates one embodiment of an electronic device configured to provide tactile feedback on a presence sensitive display in accordance with various aspects as described herein.

FIG. 2 illustrates another embodiment of an electronic device in accordance with various aspects as described herein.

FIG. 3 illustrates another embodiment of an electronic device in accordance with various aspects as described herein.

FIG. 4 illustrates one embodiment of a method performed by an electronic device of providing tactile feedback on a presence sensitive display in accordance with various aspects as described herein.

FIG. 5 illustrates another embodiment of an electronic device in accordance with various aspects as described herein.

### DETAILED DESCRIPTION

For simplicity and illustrative purposes, the present disclosure is described by referring mainly to an exemplary embodiment thereof. In the following description, numerous specific details are set forth in order to provide a thorough understanding of the present disclosure.

However, it will be readily apparent to one of ordinary skill in the art that the present disclosure may be practiced without limitation to these specific details.

The present disclosure describes, among other things, a shape-memory polymer film that is adhered to a touch screen. A shape memory polymer film can remember different shapes and can be recovered to its original form from a temporary shape via the appropriate stimulus (e.g., heat, humidity, electric field). In one example, the film can be activated via an electrical field to dynamically deform (e.g., protrude, recess) at a position on the display that corresponds to a certain virtual element (e.g., button, key, icon) displayed on the touch screen, which enables a user to locate a certain virtual element displayed on the touchscreen by touch alone. After the user has located through touch a dynamically deformed portion of the film that corresponds to a certain virtual element, the user can then activate (e.g., double click, forceful press, time extended press) that deformed position to select the virtual element, use that position as a reference to locate another virtual key, or the like.

In this disclosure, exemplary embodiments include an electronic device having a presence sensitive display device (e.g., touchscreen) with a presence sensitive display and a set of presence sensitive sensors (e.g., capacitive or resistive sensors) and a shape memory polymer film disposed on a surface of the presence sensitive display device, wherein the film is operable to dynamically deform responsive to radiated energy (e.g. heat, electricity). Each sensor is operable to detect a presence signal and radiate energy. For instance, when a presence sensitive display device detects a touch, the touchscreen can determine the location of the touch such as the horizontal (X) and vertical (Y) coordinates of the touch point on the presence sensitive display. These coordinates can be measured relative to the resolution of the presence sensitive display. Further, the presence sensitive display device can determine a touch pressure or force to detect how hard the surface of the presence sensitive display is pressed, providing a pressure value. The presence sensitive display device can also detect a touch area or size, which helps differentiate between a fingertip and a stylus. The presence sensitive display device may also perform touch identification, with each touch point being assigned a unique identifier, enabling the presence sensitive display device to track multiple touches simultaneously. In addition, the presence sensitive display device may determine the touch duration as the time that the touch remains in contact with the touchscreen, which can enable the detection of gestures like long presses. The presence sensitive display device may also detect velocity and direction of touches. A display controller of the presence sensitive display device can process this touch data and can send these touch results to the electronic device's processing circuitry, which then interprets the touch and responds accordingly. In presence sensitive display devices having capacitive touchscreen sensors, each capacitive sensor can radiate an electric field. These sensors can detect touch by measuring changes in capacitance when a conductive object (e.g., finger, stylus) disrupts the electric field. The electric field can be generated by electrodes placed beneath the touchscreen's surface and can be sensitive to touch without requiring physical pressure. In presence sensitive display devices having resistive touchscreen sensors, each resistive sensor can radiate heat such as when pressure is applied. These sensors can consist of two flexible layers separated by a gap.

When touched, the layers make contact, completing a circuit and enabling current to flow and heat to be generated.

In one embodiment, when the presence sensitive display device is displaying a graphical user interface (GUI) (e.g. car dashboard, calculator, point of sale checkout) having a set of virtual elements (e.g. a window, menu, icon, widget) and a user touches a portion of the surface of the presence sensitive display device that is proximate (i.e. within a certain distance of a portion of a surface of a presence sensitive display device to enable a presence sensitive sensor of the display device to detect a presence from that portion of the surface of the presence sensitive display device) a portion of the surface of the presence sensitive display in which one of the virtual elements is displayed, the electronic device is operable to send to the display an indication associated with a change in the energy radiated by at least one of the presence sensitive sensors proximate one of the virtual elements so as to dynamically deform the portion of the film that is proximate that virtual element, providing tactile feedback at that portion to the user of the presence sensitive display device.

There are numerous potential applications of tactile feedback on a presence sensitive display by dynamic deformation of a shape-memory polymer film disposed on a surface of the display. For example, the electronic device can be operationally coupled to a control module of a motor vehicle and operable to control a function of the motor vehicle based on a detection of a presence signal at a certain location proximate a displayed virtual element so that a user can control the function of the motor vehicle while driving without looking at the screen. In another example, the tactile feedback can be associated with a tactile pattern that corresponds to a Braille alphanumeric character, allowing for increased engagement of visually impaired users on applications run on presence sensitive displays. In another example, the virtual elements could each correspond to a button on a calculator, allowing a user to make calculations using the calculator without looking at the keys and thereby increasing the user's productivity and efficiency. In another example, in a point of sale context, tactile feedback could be used to indicate the location on the display in one point of sale application that is associated with a virtual element that when touched launches another point of sale application.

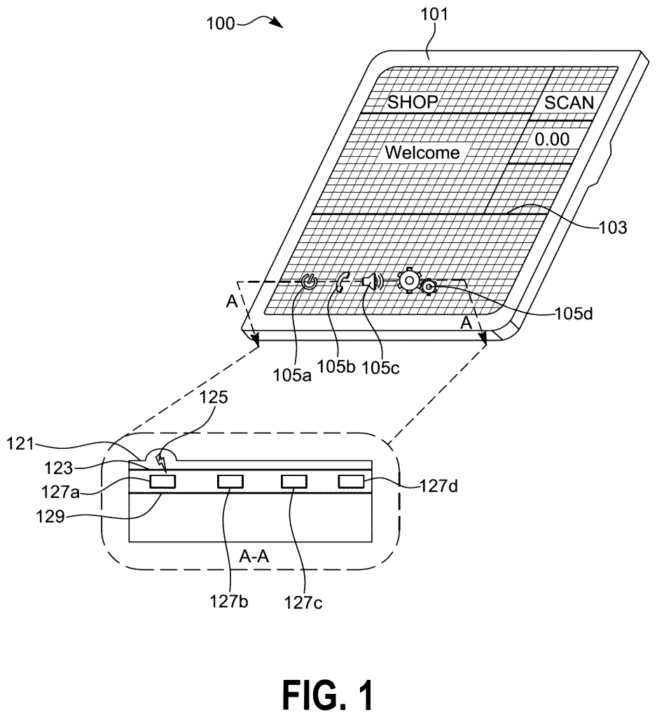

FIG. 1 illustrates one embodiment of a system 100 having an electronic device 101 that has a presence sensitive display 103. Displayed on the presence sensitive display 103 is a GUI having a set of virtual elements (105a-d). A-A shows a cross section of a portion of the presence sensitive display device that intersects the set of virtual elements (105a-d). The cross section A-A shows a shape-memory polymer film 121 disposed on a surface 123 (e.g. durable glass or other protective layer) of the presence sensitive display 103. A portion of the shape-memory polymer film 121 is operable to dynamically deform in response to a change in radiated energy 125 (e.g., electric field, heat) by presence sensitive sensors 127a-d (e.g., capacitive touchscreen sensor, resistive touchscreen sensor) proximate the portion of the shape-memory polymer film 121 and disposed between the surface 123 of the presence sensitive display and a display panel 129 (e.g. liquid crystal display, organic light-emitting diode). In FIG. 1, the grid illustrated on the display panel 109 is meant to illustrate the regions associated with the set of presence sensitive sensors 127a-d and is not displayed by the display panel 109.

In operation, a processing circuitry of the electronic device 101 can obtain a visual representation of a GUI having the set of virtual elements 105a-d. The processing circuitry can then send to the presence sensitive display device for display on the presence sensitive display 103 the visual representation of the GUI having the set of virtual elements 105a-d, which may trigger the presence sensitive display 103 to activate the display panel 129 to display the visual representation. A user of the electronic device 101 can touch a portion of the shape-memory polymer film 121 that is proximate one of the virtual elements 105a-d, which is detectable by at least one of the presence sensitive sensors 127a-d through the surface 123 of the presence sensitive display 103. The processing circuitry can then receive from the presence sensitive display device an indication that a presence is detected at a certain location (e.g., X/Y coordinates) on the presence sensitive display 103 by at least one of the presence sensitive sensors 127a-d. The processing circuitry can obtain or determine the certain location of the detected presence on the presence sensitive display 103. The processing circuitry can identify at least one of the set of virtual elements 105a-d of the GUI displayed on the presence sensitive display 103 is proximate the certain location to obtain an identified virtual element. The processing circuitry can identify at least one of the set of presence sensitive sensors 127a-d that is proximate the certain location to obtain an identified presence sensor. The processing circuitry can determine to change the energy 125 radiated by the identified presence sensor to deform a portion of the shape-memory polymer film 121 that is proximate the identified virtual element. The processing circuitry can send to the presence sensitive display device 101 an indication associated with the change in radiated energy 125 by the identified presence sensitive sensor so as to provide localized tactile feedback associated with the identified virtual element.

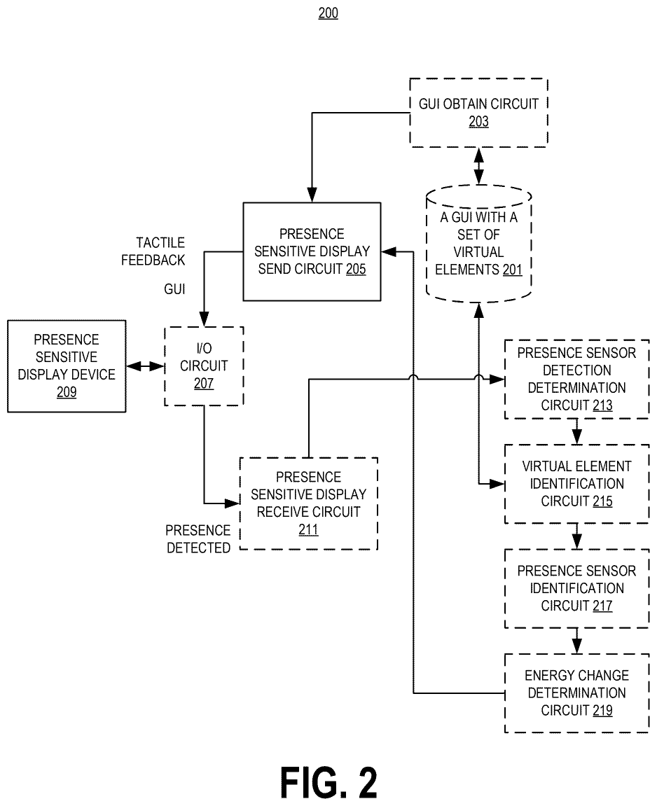

FIG. 2 illustrates one embodiment of an electronic device 200 in accordance with various aspect as described herein. In FIG. 2, the electronic device 200 implements various functional means, units, modules (e.g. via a processing circuitry, software code, or the like), or circuits. In one embodiment, these functional means, units, modules, or circuits (e.g. for implementing the method(s) described herein) may include for instance an input/output circuit 207 that is operable to transfer information to or from the functional means, units, modules, or circuits of the electronic device and a presence sensitive display device 209 having a set of presence sensitive sensors and a shape memory polymer film disposed on a surface of the presence sensitive display device 209. The functional means, units, modules or circuits can further include a GUI obtain circuit 203 operable to obtain information associated with a GUI having a set of virtual elements from a GUI database 201; a presence sensitive display send circuit 205 operable to send an indication (e.g. a representation of a GUI, a request to change the energy radiated from a presence sensitive sensor) to the presence sensitive display device 209 through the input/output circuit 207; a presence sensitive display receive circuit 211 operable to receive an indication (e.g. presence signal detection information from a presence sensitive sensor) from the presence sensitive display 209 through the input/output circuit 207; a presence sensor detection determination circuit 213 operable to determine based on a received indication that a presence signal has been detected by a presence sensitive sensor of the presence sensitive display device 209; a virtual element identification circuit 215 operable to identify a virtual element of the GUI that is proximate the presence sensitive sensor that detected the presence signal; a presence sensor identification circuit 217 operable to identify a presence sensitive sensor that is proximate the identified virtual element; and an energy change determination circuit 219 operable to determine a change in energy radiated by the identified presence sensitive sensor to deform a portion of the shape memory polymer film that is proximate the identified presence sensitive sensor.

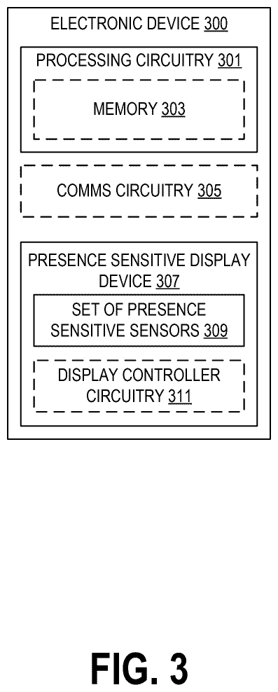

FIG. 3 illustrates another embodiment of an electronic device 300 in accordance with various aspect as described herein. In FIG. 3, the electronic device 300 can include processing circuitry 301 operably coupled to one or more of the following: a memory 303, a network communications circuitry 305, a presence sensitive display device 307 having a set of presence sensitive sensors 309, or any combination thereof. The network communications circuitry 305 can be configured to transmit and/or receive information to and/or from one or more network node devices via any communication technology. The processing circuitry 301 can be configured to perform processing described herein, such as by executing instructions stored in the memory 303. The processing circuitry 301 in this regard may implement certain functional means, units or modules. The presence sensitive display device 307 can be operably coupled to a display controller circuitry 311 and can be operable to display information, detect presence signals by a presence sensitive sensor of the set of presence sensitive sensors, and change an energy radiated from a presence sensitive sensor of the set of presence sensitive sensors.

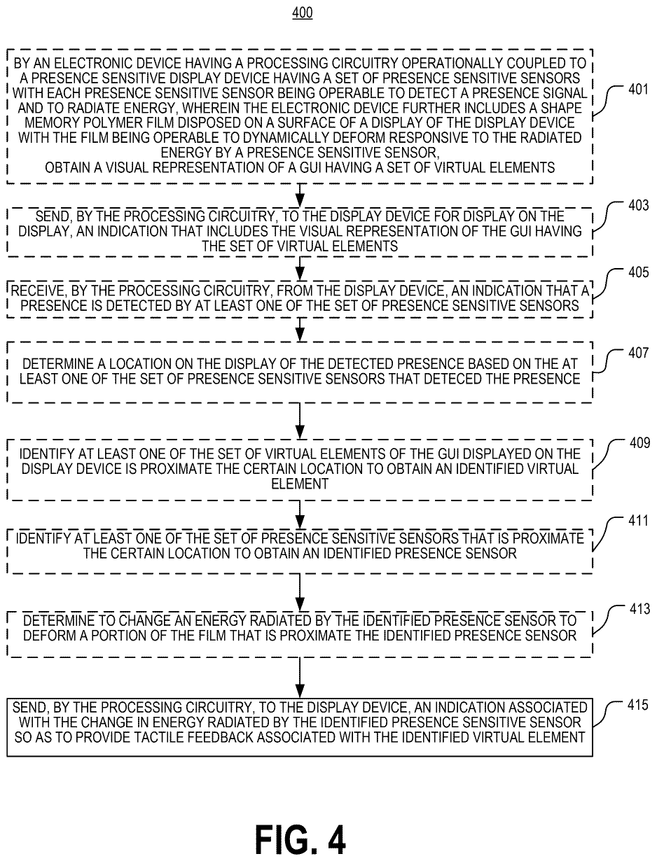

FIG. 4 illustrates one embodiment of a method 400 performed by an electronic device in accordance with various aspect as described herein. In FIG. 4, the method 400, may start, for instance, at block 401, where the method 400 can include obtaining a visual representation of a GUI having a set of virtual elements. This step could be accomplished by receiving information from a database of GUI data contained in memory of the electronic device or by receiving information over a network from a network node having a database of GUI data. At block 403, the method 400 may include sending, to a presence sensitive display device of the electronic device with the presence sensitive display device having a presence sensitive display, a set of presence sensitive sensors and a shape memory polymer film disposed on a surface of the presence sensitive display, for display on the presence sensitive display, the visual representation of the GUI having the set of virtual elements. At block 405, the method 400 may include receiving, by processing circuitry of the electronic device, from the presence sensitive display device, an indication that a presence is detected at a certain location on the presence sensitive display device. At block 407, the method 400 may include determining that at least one of the set of presence sensitive sensors detected the presence at the certain location on the presence sensitive display device. At block 409, the method 400 may include identifying at least one of the set of virtual elements of the GUI displayed on the presence sensitive display device is proximate the certain location to obtain an identified virtual element. At block 411, the method 400 may include identifying at least one of the set of presence sensitive sensors that is proximate the certain location to obtain an identified presence sensitive sensor. At block 413, the method 400 may include determining to change an energy radiated by the identified presence sensitive sensor to deform a portion of a shape memory polymer film that is proximate the identified presence sensor. At block 415, the method 400 includes sending, by the processing circuitry, to the presence sensitive display device, an indication associated with the change in energy radiated by the identified presence sensitive sensor so as to provide tactile feedback associated with the identified virtual element.

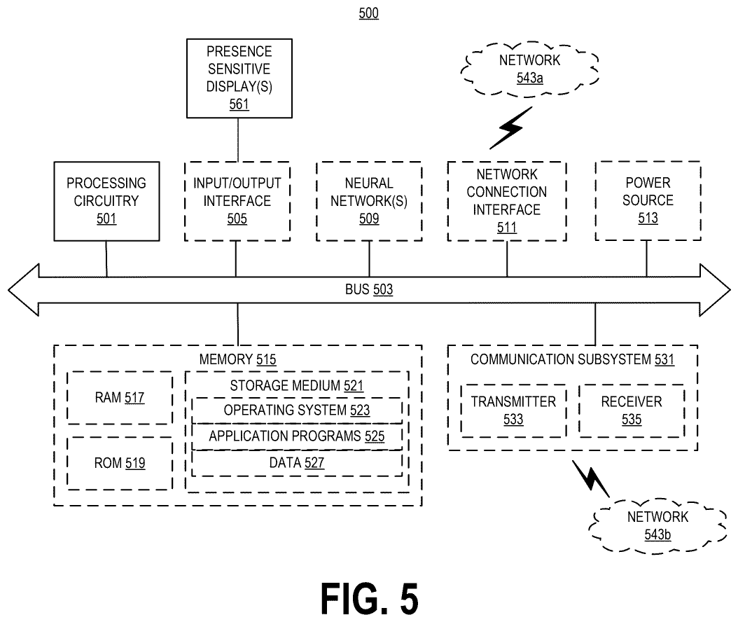

FIG. 5 illustrates another embodiment of an electronic device 500 in accordance with various aspects as described herein. In FIG. 5, device 500 includes processing circuitry 501 that is operatively coupled to input/output interface 505, artificial intelligence (Al) circuit 509, network connection interface 511, memory 515 including random access memory (RAM) 517, read-only memory (ROM) 519, and non-volatile memory 521 or the like, communication subsystem 531, power source 513, and/or any other component, or any combination thereof.

The input/output interface 505 may be configured to provide a communication interface to an input device, output device, or input and output device. The device 500 may be configured to use an output device via input/output interface 505. An output device may use the same type of interface port as an input device. For example, a USB port may be used to provide input to and output from the device 500. The output device may be a speaker, a sound card, a video card, a display device, a presence sensitive display device 561, a monitor, a printer, an actuator, an emitter, a smartcard, another output device, or any combination thereof. The device 500 may be configured to use an input device via input/output interface 505 to allow a user to capture information into the device 500. The input device may include a weight sensor (e.g., electronic weight scale), an optical sensor (e.g., camera), a presence sensitive display device 561, another input device, a scanner (e.g., barcode scanner) an accelerometer, a microphone, a sensor, a mouse, a trackball, a directional pad, a trackpad, a scroll wheel, a smartcard, and the like. The presence-sensitive display device 561 may include a capacitive or resistive touch sensor to sense input from a user. A sensor may be, for instance, an accelerometer, a gyroscope, a tilt sensor, a force sensor, a magnetometer, an optical or image sensor, an infrared sensor, a proximity sensor, another like sensor, or any combination thereof.

In FIG. 5, non-volatile memory 521 may include operating system 523, application program 525, data 527, the like, or any combination thereof. In other embodiments, non-volatile memory 521 may include other similar types of information. Certain devices may utilize all of the components shown in FIG. 5, or only a subset of the components. The level of integration between the components may vary from one device to another device. Further, certain devices may contain multiple instances of a component, such as multiple processors, memories, neural networks, network connection interfaces, transceivers, etc.

In FIG. 5, processing circuitry 501 may be configured to process computer instructions and data. Processing circuitry 501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 501 may include two central processing units (CPUs). Data may be information in a form suitable for use by a computer.

In FIG. 5, a neural network 509 may be configured to learn to perform tasks by considering examples such as performing object detection of certain objects in an image. In one example, a first Al circuit of a neural network 509 is configured to perform object detection or identification, in an image, of subjects, faces of subjects, vehicles, license plates on vehicles, or the like. Further, a second Al circuit of a neural network 509 is configured to perform detection of an activity of a subject. In FIG. 5, the network connection interface 511 may be configured to provide a communication interface to network 543a. The network 543a may encompass wired and/or wireless networks such as a local-area network (LAN), a wide-area network (WAN), a computer network, a wireless network, a telecommunications network, another like network or any combination thereof. For example, network 543a may comprise a Wi-Fi network. The network connection interface 511 may be configured to include a receiver and a transmitter interface used to communicate with one or more other devices over a communication network according to one or more communication protocols, such as Ethernet, TCP/IP, SONET, ATM, or the like. The network connection interface 511 may implement receiver and transmitter functionality appropriate to the communication network links (e.g., optical, electrical, and the like). The transmitter and receiver functions may share circuit components, software or firmware, or alternatively may be implemented separately.

The RAM 517 may be configured to interface via a bus 503 to the processing circuitry 501 to provide storage or caching of data or computer instructions during the execution of software programs such as the operating system, application programs, and device drivers.

The ROM 519 may be configured to provide computer instructions or data to processing circuitry 501. For example, the ROM 519 may be configured to store invariant low-level system code or data for basic system functions such as basic input and output (I/O), startup, or reception of keystrokes from a keyboard that are stored in a non-volatile memory. The non-volatile memory 521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, the non-volatile memory 521 may be configured to include an operating system 523, an application program 525 such as web browser, web application, user interface, browser data manager as described herein, a widget or gadget engine, or another application, and a data file 527. The non-volatile memory 521 may store, for use by the device 500, any of a variety of various operating systems or combinations of operating systems.

The non-volatile memory 521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. The non-volatile memory 521 may allow the device 500 to access computer-executable instructions, application programs or the like, stored on transitory or non-transitory memory media, to off-load data, or to upload data. An article of manufacture, such as one utilizing a communication system may be tangibly embodied in the non-volatile memory 521, which may comprise a device readable medium.

The processing circuitry 501 may be configured to communicate with network 543b using the communication subsystem 531. The network 543a and the network 543b may be the same network or networks or different network or networks. The communication subsystem 531 may be configured to include one or more transceivers used to communicate with the network 543b. For example, the communication subsystem 531 may be configured to include one or more transceivers used to communicate with one or more remote transceivers of another device capable of wireless communication according to one or more communication protocols, such as IEEE 802.11, CDMA, WCDMA, GSM, LTE, UTRAN, WiMax, or the like. Each transceiver may include a transmitter 533 and/or receiver 535 to implement transmitter or receiver functionality, respectively, appropriate to the RAN links (e.g., frequency allocations and the like). Further, transmitter 533 and receiver 535 of each transceiver may share circuit components, software, or firmware, or alternatively may be implemented separately.

In FIG. 5, the communication functions of the communication subsystem 531 may include data communication, voice communication, multimedia communication, short-range communications such as Bluetooth, near-field communication, location-based communication such as the use of the global positioning system (GPS) to determine a location, another like communication function, or any combination thereof. For example, the communication subsystem 531 may include cellular communication, Wi-Fi communication, Bluetooth communication, and GPS communication. The network 543b may encompass wired and/or wireless networks such as a local-area network (LAN), a wide-area network (WAN), a computer network, a wireless network, a telecommunications network, another like network or any combination thereof. For example, the network 543b may be a cellular network, a Wi-Fi network, and/or a near-field network. The power source 513 may be configured to provide alternating current (AC) or direct current (DC) power to components of the device 500.

The features, benefits and/or functions described herein may be implemented in one of the components of the device 500 or partitioned across multiple components of the device 500. Further, the features, benefits, and/or functions described herein may be implemented in any combination of hardware, software, or firmware. In one example, communication subsystem 531 may be configured to include any of the components described herein. Further, the processing circuitry 501 may be configured to communicate with any of such components over the bus 503. In another example, any of such components may be represented by program instructions stored in memory that when executed by the processing circuitry 501 perform the corresponding functions described herein. In another example, the functionality of any of such components may be partitioned between the processing circuitry 501 and the communication subsystem 531. In another example, the non-computationally intensive functions of any of such components may be implemented in software or firmware and the computationally intensive functions may be implemented in hardware.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts for illustrative purposes, but the embodiments are similarly applicable in other contexts not explicitly described.

In one exemplary embodiment, a method is performed by an electronic device having a presence sensitive display device with a presence sensitive display and a set of presence sensitive sensors with each presence sensitive sensor being operable to detect a presence signal and to radiate energy. The electronic device further includes a shape memory polymer film disposed on a surface of the display device with the film being operable to dynamically deform responsive to radiated energy. The method includes sending, by processing circuitry of the electronic device, to a first presence sensitive sensor of the set of presence sensitive sensors that is proximate a location on the display device in which at least one of a set of virtual elements of a GUI is displayed or will be displayed, an indication associated with changing the energy radiated from that sensor so that a portion of the film proximate at least one of the displayed or to be displayed virtual elements is radiated by the energy to enable that portion to dynamically deform so as to provide tactile feedback at that portion.

In another exemplary embodiment, the method further includes obtaining a visual representation of the GUI having a set of virtual elements.

In another exemplary embodiment, the method further includes sending, by the processing circuitry, to the presence sensitive display device, for display on the presence sensitive display, the visual representation of the GUI having the set of virtual elements.

In another exemplary embodiment, the method further includes receiving, by the processing circuitry, from the display device, an indication that a presence is detected at a certain location on the display device.

In another exemplary embodiment, the method further includes determining that at least one of the set of presence sensitive sensors detected the presence at the certain location on the display device.

In another exemplary embodiment, the method further includes identifying at least one of the set of virtual elements of the GUI displayed on the display device is proximate the certain location to obtain an identified virtual element.

In another exemplary embodiment, the method further includes identifying at least one of the set of presence sensitive sensors that is proximate to the certain location to obtain an identified presence sensitive sensor.

In another exemplary embodiment, the method further includes determining to change the energy radiated by the identified presence sensitive sensor to deform a portion of the film that is proximate the identified presence sensitive sensor.

In another exemplary embodiment, the GUI having the set of virtual elements in the method further contains data associated with a deformation of a portion of the film that is proximate one of the set of virtual elements when the visual representation of the GUI is displayed proximate the portion of the film.

In another exemplary embodiment, the method further includes identifying a virtual element of the set of virtual elements associated with the deformation data, identifying the location on the display device that is proximate the identified virtual element when the visual representation is displayed on the presence sensitive display, identifying at least one of the set of presence sensitive sensors that is proximate the identified location to obtain an identified presence sensitive sensor, and determining to change the energy radiated by the identified presence sensitive sensor to deform a portion of the film in accordance with the deformation data associated with the identified virtual element.

In another exemplary embodiment, the electronic device is operationally coupled to or integrated into a body control module of a motor vehicle and operable to control a function of the motor vehicle based on a detection of a presence signal at the certain location proximate the displayed virtual element.

In another exemplary embodiment, the deformation data associated with the identified virtual element corresponds to a Braille alphanumeric character.

In another exemplary embodiment, the method further includes sending by the processing circuitry to the presence sensitive display device an indication associated with a second visual representation of a second GUI, responsive to a detection of a presence signal at the location proximate the identified virtual element, wherein the GUI corresponds to a first navigator of a set of navigators with each navigator corresponding to a different point of sale function performed by a user, and the second GUI corresponds to a second navigator.

In another exemplary embodiment, each virtual element corresponds to a button on a calculator.

In one exemplary embodiment, an electronic device comprises a presence sensitive display device with a presence sensitive display and a set of presence sensitive sensors with each presence sensitive sensor being operable to detect a presence signal and to radiate energy. The electronic device further comprises a shape memory polymer film disposed on a surface of the display device with the film being operable to dynamically deform responsive to radiated energy. The electronic device further comprises a processing circuitry and a memory, with the memory containing instructions executable by the processing circuitry whereby the processing circuitry is configured to send, by the processing circuitry to a first presence sensitive sensor of the set of presence sensitive sensors that is proximate a location on the display in which at least one of a set of virtual elements of a GUI is displayed or will be displayed, an indication associated with changing the energy radiated from that sensor that a portion of the film proximate at least one of the displayed or to be displayed virtual elements is radiated by the energy to enable that portion to dynamically deform so as to provide tactile feedback at that portion.

In another exemplary embodiment, the processing circuitry is further configured to obtain a visual representation of the GUI having the set of virtual elements.

In another exemplary embodiment, the processing circuitry is further configured to send, by the processing circuitry, to the presence sensitive display device, for display on the presence sensitive display, the visual representation of the GUI having the set of virtual elements.

In another exemplary embodiment, the processing circuitry is further configured to receive, by the processing circuitry, from the display device, an indication that a presence is detected at a certain location on the display device.

In another exemplary embodiment, the processing circuitry is further configured to determine that at least one of the set of presence sensitive sensors detected the presence at the certain location on the display device.

In another exemplary embodiment, the processing circuitry is further configured to identify that at least one of the set of virtual elements of the GUI displayed on the display device is proximate the certain location to obtain an identified virtual element; and identify at least one of the set of presence sensitive sensors that is proximate the certain location to obtain an identified presence sensitive sensor.

In another exemplary embodiment, the processing circuitry is further configured to determine to change the energy radiated by the identified presence sensitive sensor to deform a portion of the film that is proximate the identified virtual element.

In another exemplary embodiment, the GUI having the set of virtual elements contains data associated with a deformation of a portion of the film that is proximate one of the set of virtual elements when the visual representation of the GUI is displayed proximate the portion of the film.

In another exemplary embodiment, the processing circuitry is further configured to identify a virtual element of the set of virtual elements associated with the deformation data, identify the location on the display device that is proximate the identified virtual element when the visual representation is displayed on the presence sensitive display, identify at least one of the set of presence sensitive sensors that is proximate the identified location to obtain an identified presence sensitive sensor, and determine to change the energy radiated by the identified presence sensitive sensor to deform a portion of the film in accordance with the deformation data associated with the identified virtual element.

In one exemplary embodiment, a system includes a presence sensitive display device with a presence sensitive display operable to display and having a set of presence sensitive sensors with each presence sensitive sensor operable to detect a presence signal and to radiate energy. The system further includes a shape memory polymer film disposed on a surface of the presence sensitive display and operable to dynamically deform responsive to radiated energy. The system also includes a processing circuitry and a memory with the memory containing instructions executable by the processor processing circuitry whereby the processing circuitry is configured to send, to a first presence sensitive sensor of the set of presence sensitive sensors that is proximate a certain location on the presence sensitive display in which a first virtual element of a set of virtual elements of a graphical user interface is displayed, an indication associated with changing the energy radiated by the first presence sensitive sensor so that a portion of the film proximate the first presence sensitive sensor is radiated by the energy to enable that portion of the film to dynamically deform so as to provide tactile feedback proximate the first virtual element.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods, devices and systems described herein. Alternatively, some or all functions could be implemented by a state machine that has no stored program instructions, or in one or more application specific integrated circuits (ASICs), in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the subject matter of this disclosure.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

1. A method, comprising:
by an electronic device having processing circuitry operably coupled to a presence sensitive display device having a presence sensitive display operable to display and having a set of presence sensitive sensors with each presence sensitive sensor being operable to sense a presence signal and to radiate energy, wherein the electronic device further includes a shape memory polymer film disposed on a surface of the presence sensitive display and operable to dynamically deform responsive to radiated energy,
receiving, by the processing circuitry, from the presence sensitive display device, an indication that a presence is sensed by a first presence sensitive sensor of the set of presence sensitive sensors and proximate a certain location on the presence sensitive display in which a first virtual element of a set of virtual elements of a graphical user interface is displayed;
sending, by the processing circuitry of the electronic device, to the first presence sensitive sensor of the set of presence sensitive sensors an indication associated with changing the energy radiated from that sensor; and
causing the first presence sensitive sensor to change the energy radiated such that a portion of the film proximate the first presence sensitive sensor is dynamically deformed to provide tactile feedback proximate the first virtual element.

2. The method of claim 1, further comprising:
obtaining a visual representation of the graphical user interface having the set of virtual elements.

3. The method of claim 2, further comprising:
sending, by the processing circuitry, to the presence sensitive display device, for display on the presence sensitive display, the visual representation of the graphical user interface having the set of virtual elements.

4. The method of claim 1, further comprising:
determining, by the processing circuitry, based on the indication received from the presence sensitive display device, the certain location on the presence sensitive display at which the presence is sensed.

5. (canceled)

6. The method of claim 4, further comprising:
identifying at least one of the set of virtual elements of the graphical user interface displayed on the presence sensitive display that is proximate the certain location to obtain an identified virtual element.

7. The method of claim 4, further comprising:
identifying at least one of the set of presence sensitive sensors that is proximate the certain location to obtain an identified presence sensitive sensor.

8. The method of claim 4, further comprising:
identifying at least one of the set of virtual elements of the graphical user interface displayed on the presence sensitive display that is proximate the certain location to obtain an identified virtual element;
identifying at least one of the set of presence sensitive sensors that is proximate the certain location to obtain an identified presence sensitive sensor; and
determining to change the energy radiated by the identified presence sensitive sensor to deform the portion of the film that is proximate the identified virtual element.

9. The method of claim 2, wherein the graphical user interface having a set of virtual elements contains data associated with a deformation of a portion of the film that is proximate one of the set of virtual elements when the visual representation of the graphical user interface is displayed on the presence sensitive display of the presence sensitive display device.

10. The method of claim 9, further comprising:
identifying one virtual element of the set of virtual elements associated with the deformation data to obtain an identified virtual element;
identifying the location on the presence sensitive display device that is proximate the identified virtual element when the visual representation is displayed on the presence sensitive display device to obtain an identified location;
identifying at least one of the set of presence sensitive sensors that is proximate the identified location to obtain an identified presence sensitive sensor; and
determining to change the energy radiated by the identified presence sensitive sensor to deform the portion of the film proximate the identified virtual element in accordance with the deformation data associated with the identified virtual element.

11. An electronic device, comprising:
with the electronic device having processing circuitry operably coupled to a presence sensitive display device having a presence sensitive display operable to display and having a set of presence sensitive sensors with each presence sensitive sensor being operable to sense a presence signal and to radiate energy, wherein the electronic device further includes a shape memory polymer film disposed on a surface of the presence sensitive display and operable to dynamically deform responsive to radiated energy; and
wherein the electronic device further includes a memory, with the memory containing instructions executable by the processing circuitry whereby the processing circuitry is configured to:
receive, by the processing circuitry, from the presence sensitive display device, an indication that a presence is sensed by a first presence sensitive sensor of the set of presence sensitive sensors and proximate a certain location on the presence sensitive display in which a first virtual element of a set of virtual elements of a graphical user interface is displayed;
send, by the processing circuitry of the electronic device, to the first presence sensitive sensor of the set of presence sensitive sensors an indication associated with changing the energy radiated from the first presence sensitive sensor; and
cause the first presence sensitive sensor to change the energy radiated such that a portion of the film proximate the first presence sensitive sensor is dynamically deformed to provide tactile feedback proximate the first virtual element.

12. The electronic device of claim 11, wherein the memory contains instructions executable by the processing circuitry whereby the processing circuitry is further configured to:
obtain a visual representation of the graphical user interface having the set of virtual elements.

13. The electronic device of claim 12, wherein the memory contains instructions executable by the processing circuitry whereby the processing circuitry is further configured to:
send, by the processing circuitry, to the presence sensitive display device, for display on the presence sensitive display, the visual representation of the graphical user interface having the set of virtual elements.

14. The electronic device of claim 11, wherein the memory contains instructions executable by the processing circuitry whereby the processing circuitry is further configured to:
determine, by the processing circuitry, based on the indication received from the presence sensitive display device,
the certain location on the presence sensitive display device at which the presence is sensed.

15. (canceled)

16. The electronic device of claim 14, wherein the memory contains instructions executable by the processing circuitry whereby the processing circuitry is further configured to:
identify at least one of the set of virtual elements of the graphical user interface displayed on the presence sensitive display that is proximate the certain location to obtain an identified virtual element; and
identify at least one of the set of presence sensitive sensors that is proximate the certain location to obtain an identified presence sensitive sensor.

17. The electronic device of claim 16, wherein the memory contains instructions executable by the processing circuitry whereby the processing circuitry is further configured to:
determine to change the energy radiated by the identified presence sensitive sensor to deform a portion of the film that is proximate the identified virtual element.

18. The electronic device of claim 12, wherein the graphical user interface having the set of virtual elements contains data associated with a deformation of the portion of the film that is proximate one of the set of virtual elements when the visual representation of the graphical user interface is displayed on the presence sensitive display of the presence sensitive display device.

19. The electronic device of claim 18, wherein the memory contains instructions executable by the processing circuitry whereby the processing circuitry is further configured to:
identify a virtual element of the set of virtual elements associated with the deformation data to obtain an identified virtual element;
identify the location on the presence sensitive display that is proximate the identified virtual element when the visual representation is displayed on the presence sensitive display to obtain an identified location;
identify at least one of the set of presence sensitive sensors that is proximate the identified location to obtain an identified presence sensitive sensor; and
determine to change the energy radiated by the identified presence sensitive sensor to deform a portion of the film proximate the identified virtual element in accordance with the deformation data associated with the identified virtual element.

20. A system, comprising:
a presence sensitive display device having a presence sensitive display operable to display and having a set of presence sensitive sensors with each presence sensitive sensor operable to sense a presence signal and to radiate energy;
a shape memory polymer film disposed on a surface of the presence sensitive display and operable to dynamically deform responsive to radiated energy; and
a processing circuitry and a memory, with the processing circuitry operably coupled to the presence sensitive display device and the memory containing instructions executable by the processor processing circuitry whereby the processing circuitry is configured to:
receive, by the processing circuitry, from the presence sensitive display device, an indication that a presence is sensed by a first presence sensitive sensor of the set of presence sensitive sensors and proximate a certain location on the presence sensitive display in which a first virtual element of a set of virtual elements of a graphical user interface is displayed;
send, by the processing circuitry, to the first presence sensitive sensor of the set of presence sensitive sensors, an indication associated with changing the energy radiated by the first presence sensitive sensor; and
cause the first presence sensitive sensor to change the energy radiated such that a portion of the film proximate the first presence sensitive sensor is dynamically deformed to provide tactile feedback proximate the first virtual element.
